(19) United States
(12) Patent Application Publication
(10) Pub. No.: US 2026/0081734 A1
(43) Pub. Date: Mar. 19, 2026

(54) SYSTEMS AND METHODS FOR SINGLE DOWNLINK CONTROL INFORMATION SIMULTANEOUS SPATIAL DIVISION MULTIPLEXING PHYSICAL UPLINK SHARED CHANNEL TRANSMISSION WITH SINGLE SOUNDING REFERENCE SIGNAL RESOURCE SET

(71) Applicant: APPLE INC., Cupertino, CA (US)

(72) Inventors: Haitong Sun, Cupertino, CA (US); Hong He, San Jose, CA (US); Dawei Zhang, Saratoga, CA (US); Seyed Ali Akbar Fakoorian, San Diego, CA (US); Huaning Niu, San Jose, CA (US); Wei Zeng, San Diego, CA (US)

(21) Appl. No.: 19/110,310

(22) PCT Filed: Sep. 29, 2022
(86) PCT No.: PCT/US2022/077219

§ 371 Date: Mar. 10, 2025

(51) Int. Cl. H04L 5/00; H04L 27/26

(52) U.S. Cl. CPC H04L 5/0044; H04L 27/261

(57) ABSTRACT

Systems and methods for single downlink control information (DCI) based simultaneous physical uplink shared channel (PUSCH) transmission with spatial division multiplexing (SDM) using a sounding reference signal (SRS) resource set are disclosed herein. The SRS resource set may be an exclusive (e.g., single) SRS resource set for either a non-codebook-based or a codebook-based simultaneous physical uplink shared channel (PUSCH) operation. In each case, a user equipment (UE) transmits the SRS resource(s) of the SRS resource set, receives a DCI from the network that schedules a first PUSCH transmission on a first UE panel and a simultaneous second PUSCH transmission on a second UE panel, and then transmits the (simultaneous) PUSCH transmissions as scheduled. Related network-side functionality is also discussed. In cases, SRS resources (and/or one or more SRS ports used by the SRS resource) are mapped to a particular UE panel. In other cases, SRS resources use both UE panels.

### TECHNICAL FIELD

This application relates generally to wireless communication systems, including wireless communications systems using either/both codebook-based PUSCH operation and non-codebook-based PUSCH operation.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram corresponding to simultaneous transmission of multiple PUSCHs to a network from multiple panels of a UE, according to embodiments.

FIG. 2 illustrates an SRS resource set with SRS resources arranged in pairs, according to embodiments herein.

FIG. 3 illustrates an SRS resource set with SRS resources arranged in subsets, according to embodiments herein.

FIG. 4 illustrates a diagram showing various precoding matrices that may be indicated in DCI.

FIG. 5 illustrates a method of a UE, according to embodiments herein.

FIG. 6 illustrates a method of a RAN, according to embodiments herein.

FIG. 7 illustrates a method of a UE, according to embodiments herein.

FIG. 8 illustrates a method of a RAN, according to embodiments herein.

FIG. 9 illustrates an example architecture of a wireless communication system, according to embodiments disclosed herein.

FIG. 10 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In some deployments, NR uplink (UL) operation supports two multiple input multiple output (MIMO) operation modes with the use of up to 4 layers.

Further, in some deployments, codebook based UL operation may be supported. In some such cases, a sounding reference signal (SRS) resource set having one or more SRS resources used for UL channel sounding may be for a codebook based UL operation (e.g., an SRS resource set with usage=“codebook”). When using the SRS resource set for UL channel sounding, the UE transmits each of the SRS resources of the set using multiple ports. Based on its receipt of these SRS resources, a network schedules a physical uplink shared channel (PUSCH) by indicating one of the SRS resources using an SRS resource indicator (SRI), and additionally provides a transmit precoding matrix indicator (TPMI) for a precoding matrix that the UE is to apply with the SRS ports for transmitting the PUSCH, as well as a corresponding rank indication (RI). The UE transmits the PUSCH according to port configuration that was used by the indicated SRS.

In some cases, an SRS resource set having one or more of SRS resources used for UL channel sounding may be for a non-codebook based UL operation (e.g., an SRS resource set with usage=“non-codebook”). When using the SRS resource set for UL channel sounding, the UE transmits each SRS resource with a single SRS port. Based on its receipt of these SRS resources, the network schedules PUSCH by indicating one of the SRS resources/SRS ports using an SRI. The UE then transmits the PUSCH on the port(s) of the indicated SRS resource(s).

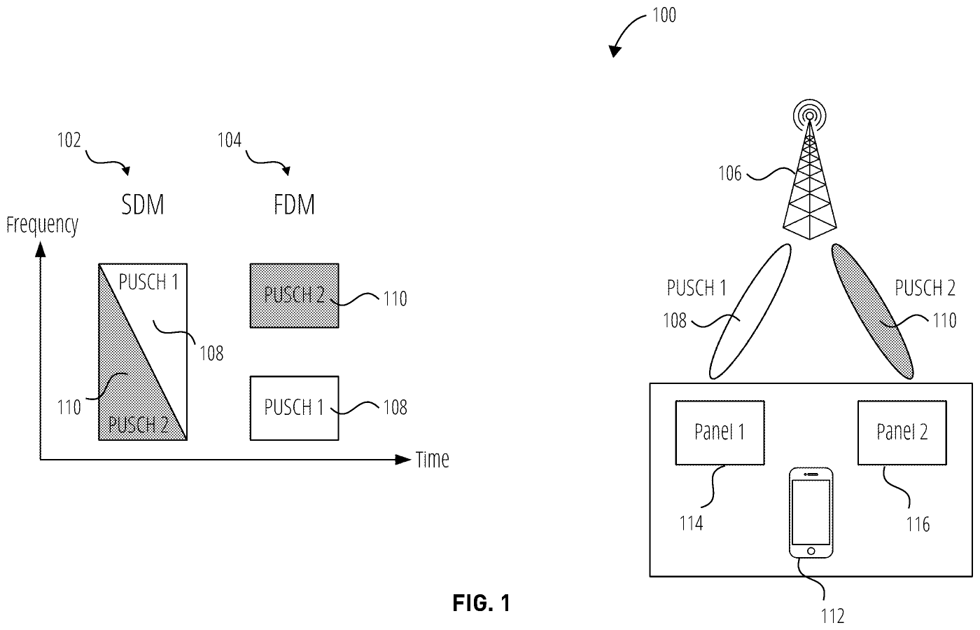

FIG. 1 illustrates a diagram 100 corresponding to simultaneous transmission of multiple PUSCHs 108, 110 to a network 106 from multiple panels 114, 116 of a UE 112, according to embodiments. In case when simultaneous transmission of PUSCH needs to be supported by NR, there may be two manners for simultaneous transmission of PUSCH, spatial division multiplexing (SDM) and frequency division multiplexing (FDM).

In SDM, each of multiple PUSCHs is sent by the UE at the same time. Additionally, each of the multiple PUSCHs uses the same (or at least overlapping) frequency resources. Accordingly, the diagram 100 illustrates under the SDM visualization 102 that a first PUSCH 108 and a second PUSCH 110 are sent at the same time and using the same frequency resources. Spatial transmission characteristics are set differently for each of the PUSCHs (e.g., at each UE panel 114, 116) to allow for differentiation of the PUSCHs at the network.

In FDM, each of multiple PUSCHs is sent by the UE at the same time, but using non-overlapping frequency resources. Accordingly, the diagram 100 illustrates under the FDM visualization 104 that the first PUSCH 108 and the second PUSCH 110 are sent at the same time but using different sets frequency resources. The network can differentiate between the multiple PUSCHs based on their different frequency ranges.

As illustrated, one way that the UE can send simultaneous PUSCHs is via the use of multiple UE panels. For example, the diagram 100 illustrates that the first PUSCH 108 is transmitted to the network 106 by a first UE panel 114, and that the second PUSCH 110 is transmitted to the network 106 by a second UE panel 116. In the FDM case, it may be that each of the UE panels is configured to transmit in the frequency range corresponding to their associated PUSCH. In the SDM case, it may be that each of the UE panels is configured to transmit in the same frequency range, but with different spatial characteristics for their corresponding PUSCH.

Downlink control information (DCI) based simultaneous (e.g., simultaneous multiple panel (STxMP)) PUSCH transmissions using SDM are contemplated by embodiments herein. Compared to FDM, SDM allows a UE to use multiple UE panels to increase a maximum number of layers that a PUSCH can be transmitted with, which may ultimately provide a higher peak data rate for UL communication. In some cases described herein, single DCI codebook-based simultaneous PUSCH transmissions methods are used. It may be embodiments for single DCI codebook-based simultaneous PUSCH transmission methods may assume and/or function in situations involving the use of one, multiple, or all of coherent precoding, partial-coherent precoding, and/or non-coherent precoding. In other cases described herein, single DCI non-codebook-based simultaneous PUSCH transmission methods are used.

Finally, under either single DCI codebook-based or single DCI non-codebook-based simultaneous PUSCH transmission methods described herein, an SRS resource set that is configured to the UE may be an SRS resource set that is an exclusive SRS resource set for the simultaneous PUSCH transmissions. This means in such cases that the SRS resource set is the only SRS resource set that is used at the UE corresponding to simultaneous PUSCH transmissions.

Accordingly, in embodiments discussed herein, it is contemplated that an SRS resource set is transmitted from the UE to the network. Based on the received SRS resources of the SRS resource set, the network prepares and sends the UE a single DCI that schedules simultaneous PUSCH transmissions (e.g., with one on each of two UE panels). This DCI may indicate one or more of the SRS resources. The UE accordingly prepares and sends the scheduled PUSCH transmissions on their corresponding UE panels, where characteristics of such PUSCHs are based on any corresponding SRS resource(s) indicated in the DCI.

### Exclusive SRS Resource Set Embodiments for Codebook-Based Simultaneous PUSCH Operation

In a first embodiment for a single DCI codebook-based simultaneous PUSCH transmission with SDM, it may be that an exclusive SRS resource set configured at the UE for simultaneous PUSCH transmissions is codebook-based (e.g., usage=“codebook”).

In a first option under the first embodiment, it may be that in the case that the UE is not configured for a full power transmission mode 2, the number of SRS resources in the SRS resource set is greater than two. Further, in the case that the UE is configured for a full power transmission mode 2, the number of SRS resources in the SRS resource set is greater than four.

The values of two and four as described here may be as specified in a definition for a wireless communication system that does not perform simultaneous PUSCH transmissions as discussed herein. It will be understood that the additional number of SRS resources in the SRS resource set over the number supplied in such a definition provides the UE with additional flexibility in performing SRS sounding across multiple UE panels over that provided under the more restrictive definitions for other wireless communications systems.

In some cases, a maximum number of SRS resources in an SRS resource set used by the UE for simultaneous PUSCH operation when the UE is configured not to use a full power transmission mode 2 may be four (which may be doubled from definitions of other wireless communications systems not implementing simultaneous PUSCH operation, which may use an SRS resource set having two resources in such cases). Further, in some cases, a maximum number of SRS resources in an SRS resource set used by the UE for simultaneous PUSCH operation when the UE is configured to use a full power transmission mode 2 may be eight (which may be doubled from definitions of other wireless communications systems not implementing simultaneous PUSCH operation, which may use an SRS resource set having four resources in such cases).

As second option under the first embodiment, it may be that a maximum number of SRS resources in an SRS resource set used by the UE for simultaneous PUSCH operation matches that as defined for a wireless communication system not implementing simultaneous PUSCH operation.

In a second embodiment for a single DCI codebook-based simultaneous PUSCH transmission with SDM, it may be that an exclusive SRS resource set configured at the UE for simultaneous PUSCH transmissions is codebook-based. Further, it may be that a maximum number of SRS resources in an SRS resource set used by the UE for simultaneous PUSCH operation matches that as defined for a wireless communication system not implementing simultaneous PUSCH operation. Finally, it may be that the second embodiment corresponds to a case where either a non-coherent or a partial-coherent codebook is used.

Under the second embodiment, for the use of a number N of transmit (Tx) ports across two UE panels, each UE panel is assumed to have N/2 coherent Tx ports. Further, Tx ports found on different UE panels are assumed to be non-coherent. Then, for one or more SRS resources of an SRS resource set that are sent corresponding to the use of simultaneous PUSCH transmissions across the two UE panels, even SRS ports are mapped to the first UE panel, and odd SRS ports are mapped to the second UE panel.

For example, in the case of four total Tx ports across two UE panels, each UE panel is assumed to have two coherent Tx ports. Further, Tx ports from different UE panels are non-coherent. In such a case, the SRS ports to UE panel mapping is that even SRS ports 0 and 2 belong to the first UE panel, and odd SRS ports 1 and 3 belong to the second UE panel.

As another example, in the case of eight total Tx ports across two UE panels, each UE panel is assumed to have four coherent Tx ports. Further, Tx ports from different UE panels are non-coherent. In such a case the SRS ports to UE panel mapping is that even SRS ports 0, 2, 4, and 6 belong to the first UE panel, and odd SRS ports 1, 3, 5, and 7 belong to the second UE panel.

In a third embodiment for a single DCI codebook-based simultaneous PUSCH transmission with SDM, it may be that an exclusive SRS resource set configured at the UE for simultaneous PUSCH transmissions is codebook-based. Further, it may be that a maximum number of SRS resources in the SRS resource set used by the UE for simultaneous PUSCH operation matches that as defined for a wireless communication system not implementing simultaneous PUSCH operation. Finally, it may be that the third embodiment corresponds to a case where beam indications are used to inform the UE of UL beams for use.

Under the third embodiment, up to two spatialRelationInfo parameters can be provided in a configuration for each of the SRS resources of the SRS resource set. Each of the up to two spatialRelationInfo parameters may correspond to a (e.g., different) beamforming (and corresponding power control information) that is used by one of two UE panels used for simultaneous PUSCH transmissions.

Then, transmissions of SRS resources (or ports of an SRS resource) corresponding to the first UE panel are performed using the first beamforming (and corresponding power control information) for the first UE panel. Further, transmissions of SRS resources (or ports of an SRS resource) corresponding to the second UE panel are performed using the second beamforming (and corresponding power control information) for the second UE panel.

Note that in cases where SRS ports are spread across each of the UE panels, even ports may be associated with the first UE panel and odd ports may be associated with the second UE panel, as is discussed herein.

In a fourth embodiment for a single DCI codebook-based simultaneous PUSCH transmission with SDM, it may be that an exclusive SRS resource set configured at the UE for simultaneous PUSCH transmissions is codebook-based. Further, it may be that a maximum number of SRS resources in the SRS resource set used by the UE for simultaneous PUSCH operation matches that as defined for a wireless communication system not implementing simultaneous PUSCH operation. Finally, it may be that the fourth embodiment corresponds to a case where transmission configuration indicator (TCI) states are used to inform the UE of the manner of performing UL transmission. It is contemplated that such TCI states could be, for example, UL TCI states and/or joint UL/downlink (DL) TCI states.

Under the fourth embodiment, up to two TCI states can be provided in a configuration for each of the SRS resources of the SRS resource set. Each of the up to two TCI states may correspond to a (e.g., different) manner of UL transmission (e.g., beamforming and/or power control) that is used by one of two UE panels used for simultaneous PUSCH transmission. It is contemplated that, for example, the up to two TCI states in the configuration for the SRS resources could be two UL TCI states, two joint UL/DL TCI states, or a combination of a UL TCI state and a joint UL/DL TCI state.

Then, transmissions of SRS resources (or ports of an SRS resource) corresponding to the first UE panel are performed using the TCI state parameters associated with the first UE panel. Further, transmissions of SRS resources (or ports of an SRS resource) corresponding to the second UE panel are performed using the TCI state parameters associated with the second UE panel.

Note that in cases where SRS ports are spread across each of the UE panels, even ports may be associated with the first UE panel and odd ports may be associated with the second UE panel, as is discussed herein.

In a fifth embodiment for a single DCI codebook-based simultaneous PUSCH transmission with SDM, it may be that an exclusive SRS resource set configured at the UE for simultaneous PUSCH transmissions is codebook-based. Further, it may be that a maximum number of SRS resources in the SRS resource set used by the UE for simultaneous PUSCH operation is more than that defined for a wireless communication system not implementing simultaneous PUSCH operation.

Under a first option under the fifth embodiment, an SRS resource set may be configured with one or more pairs of SRS resources. Each pair of SRS resources has a first SRS resource that is used on (e.g., transmitted) on a first UE panel and a second SRS resource that is used on a second UE panel. Further, each pair corresponds to a unique SRS resource indicator (SRI) value.

Upon receiving the SRS resources of the SRS resource set, the network selects one pair of SRS resources and indicates this selection back to the UE using the corresponding SRI value in an SRI in the scheduling DCI. The first PUSCH transmission is then sent on the first UE panel according to the first SRS resource of the selected pair, and the second PUSCH transmission is (simultaneously) sent on the second UE panel according to the second SRS resource of the selected pair.

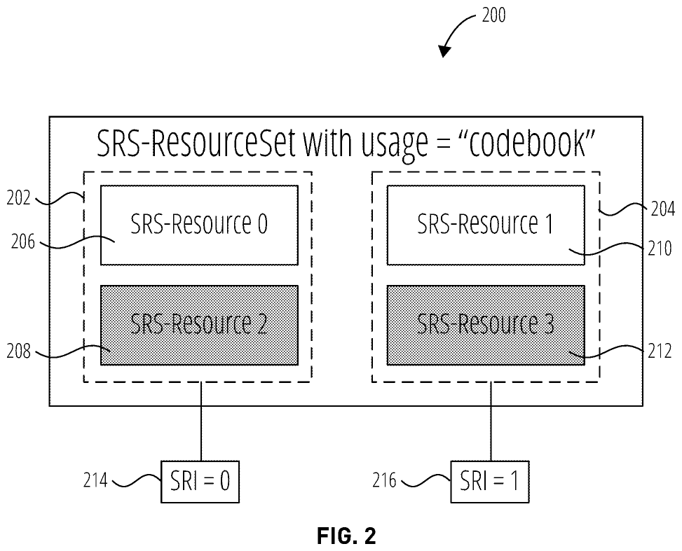

FIG. 2 illustrates an SRS resource set 200 with SRS resources arranged in pairs 202 204, according to embodiments herein. The first SRS resource pair 202 includes the SRS resource 0 206 for a first UE panel and an SRS resource 2 208 for a second UE panel. The second SRS resource pair 204 includes the SRS resource 1 210 for the first UE panel and the SRS resource 3 212 for the second UE panel.

The first SRS resource pair 202 is associated with the first SRI value 214 (e.g., “0”). The second SRS resource pair 204 is associated with the second SRI value 216 (e.g., “1”).

Once the SRS resource set 200 is transmitted by the UE (with the SRS resources 206, 208, 210, 212 being sent on their corresponding UE panel), the network can indicate one of the pairs 202, 204 using the corresponding one of the first SRI value 214 and the second SRI value 216 in an SRI in DCI. In response, the UE prepares and sends a first PUSCH transmission for the first UE panel (corresponding to the one of the SRS resources of the indicated pair that is for the first panel) and a (simultaneous) second PUSCH transmission for the second UE panel (corresponding to the other of the SRS resources of the indicated pair that is for the second UE panel).

Under a second option under the fifth embodiment, an SRS resource set may be configured with one or more subsets of SRS resources. Each subset of SRS resources contains SRS resources that are for a same UE panel.

The second option contemplates the use of multiple SRIs, with one SRI corresponding to each subset of SRS resources in the configured SRS resource set. Further, each SRS resource in a subset corresponds to one unique SRI value for its corresponding SRI.

Upon receiving the SRS resources of the SRS resource set, the network selects an SRS resource from each of the subsets of SRS resources. These selections are indicated in DCI by placing the SRI value for the selected SRS resource from the SRS subset into the SRI corresponding to that subset. Simultaneous PUSCH transmissions are then prepared and sent on each UE panel based on its corresponding indicated SRS resource (and according to that indicated SRS resource).

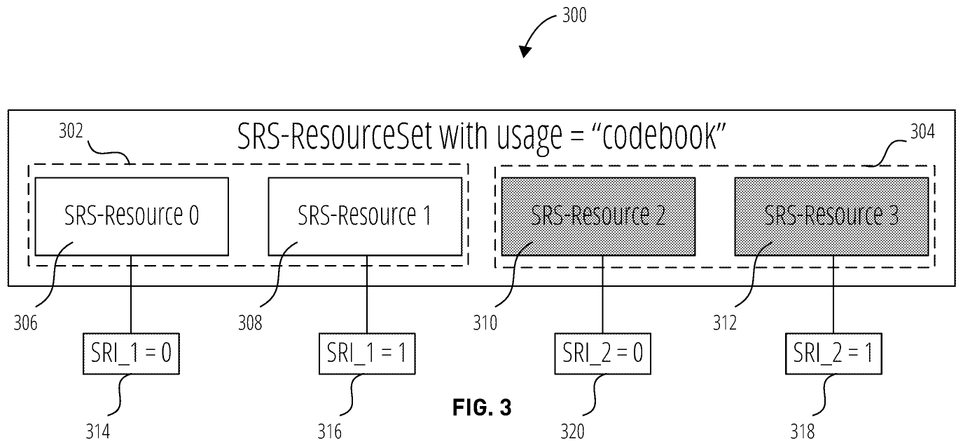

FIG. 3 illustrates an SRS resource set 300 with SRS resources arranged in subsets 302, 304, according to embodiments herein. The first subset of SRS resources 302 includes the SRS resource 0 306 and the SRS resource 1 308, each for a first UE panel. The second subset of SRS resources 304 includes the SRS resource 2 310 and the SRS resource 3 312, each for a second UE panel.

The first subset of SRS resources 302 is associated with a first SRI (“SRI_1”). The SRS resource 0 306 is associated with a first value 314 (e.g., “0”) for the first SRI. The SRS resource 1 308 is associated with a second value 316 (e.g., “1”) for the first SRI.

The second subset of SRS resources 304 is associated with a first SRI (“SRI_2”). The SRS resource 2 310 is associated with a first value 320 (e.g., “0”) for the second SRI. The SRS resource 3 312 is associated with a second value 318 (e.g., “1”) for the second SRI.

Once the SRS resource set 300 is transmitted by the UE (with the SRS resources 306, 308, 310, and 312 being sent on their corresponding UE panel), the network can indicate an SRI value for one SRS resource in each of the subsets 302, 304 using by placing the appropriate value for the desired SRS resource from a given subset 302, 304 in the corresponding one of the two SRIs. In response, the UE prepares and sends a first PUSCH transmission for the first UE panel (corresponding to the indicated one of the SRS resources 306, 308 of the first subset of SRS resources 302) and a (simultaneous) second PUSCH transmission for the second UE panel (corresponding to the indicated one of the SRS resources 310, 312 of the second subset of SRS resources 304).

This second option under this fifth embodiment may provide additional flexibility over the first option under this fifth embodiment as described herein, at the expense of additional signaling overhead (corresponding to the use of multiple SRIs in the second option) in the scheduling DCI.

In a sixth embodiment for a single DCI codebook-based simultaneous PUSCH transmission with SDM, it may be that an exclusive SRS resource set configured at the UE for simultaneous PUSCH transmissions is codebook-based. Further, it may be that a maximum number of SRS resources in the SRS resource set used by the UE for simultaneous PUSCH operation is more than that as defined for a wireless communication system not implementing simultaneous PUSCH operation.

In a first option under the sixth embodiment, it may be that, after receiving the SRS resource set, the network is configured to provide the UE a single TPMI field in DCI. In such cases, when generating simultaneous PUSCH transmission with SDM using two UE panels, the (single) indicated precoding matrix is applied with all SRS ports used by the SRS resources of the SRS resource set, and maps to both UE panels.

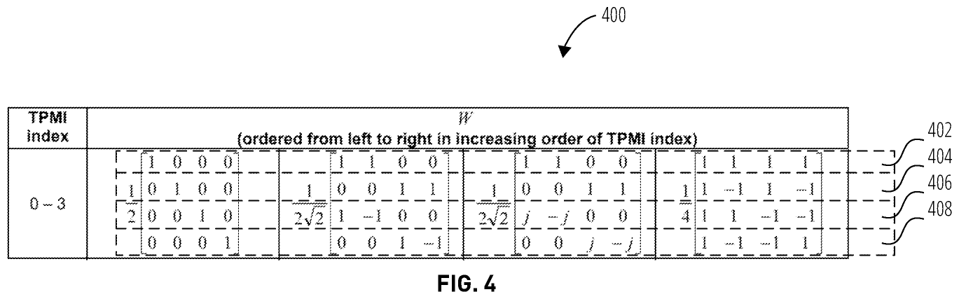

FIG. 4 illustrates a diagram 400 showing various precoding matrices that may be indicated in DCI. Note that while four are illustrated, it may be case that only one of these is indicated in the DCI. Further, note that the example precoding matrices in FIG. 4 are given by way of example and not by way of limitation (other precoding matrices are possible).

It may be that in such cases where a single precoding matrix is indicated, some of the SRS ports map to even rows of the indicated precoding matrix and others of the SRS ports map to odd rows of the indicated precoding matrix. For example, under a first case of the first option of the first embodiment, it may be that even SRS ports used by the SRS resources map to even rows of the indicated precoding matrix, and that odd SRS ports used by the SRS resource map to odd rows of the indicated precoding matrix. Under this first case, and assuming a case of four SRS ports used by the SRS resources and a rank four precoder matrix (as in one of the four precoder matrices illustrated in FIG. 4), it may be that first SRS port of the SRS resources may be mapped to a first row 402 of the applicable precoding matrix. Further, a second SRS port used by the SRS resources may be mapped to a second row 404 of the applicable precoding matrix. Further, a third SRS port used by the SRS resources may be mapped to a third row 406 of the applicable precoding matrix. Finally, a fourth SRS port used by the SRS resources may be mapped to a fourth row 408 of the applicable precoding matrix. It may be that the first and third SRS port are even SRS ports (e.g., SRS ports 0 and 2), while the second and fourth SRS ports are odd SRS ports (e.g., SRS ports 1 and 3).

In other cases, a different mapping of SRS ports to precoding matrix rows may be used. For example, under a second case of the first option of the first embodiment, it may be that two SRS resources, each with two SRS ports, can be configured for codebook-based PUSCH operation, and each SRS resource is configured for its corresponding panel. It may be that first SRS port of the first SRS resource may be mapped to a first row 402 of the applicable precoding matrix. Further, a first SRS port used by the second SRS resource may be mapped to a second row 404 of the applicable precoding matrix. Further, a second SRS port used by the first SRS resource may be mapped to a third row 406 of the applicable precoding matrix. Finally, a second SRS port used by the second SRS resource may be mapped to a fourth row 408 of the applicable precoding matrix.

In a second option under the sixth embodiment, it may be that, after receiving the SRS resource set, the network is configured to provide the UE with two TPMI fields in DCI. In such cases, when generating simultaneous PUSCH transmissions with SDM using two UE panels, a first of the two indicated precoding matrices is applied with the SRS ports used by the SRS resources of the SRS resource set that are mapped to the first UE panel, and a second of the two indicated precoding matrices is applied with the SRS ports used by the SRS resources of the SRS resource set that are mapped to the second UE panel.

In a seventh embodiment for a single DCI codebook-based simultaneous PUSCH transmission with SDM, it may be that an exclusive SRS resource set configured at the UE for simultaneous PUSCH transmissions is codebook-based. Further, it may be that a maximum number of SRS resources in the SRS resource set used by the UE for simultaneous PUSCH operation is more than that defined for a wireless communication system not implementing simultaneous PUSCH operation. Under the seventh embodiment, there may be a single antenna ports field provided by the network in DCI.

Under a first option under the seventh embodiment, the (single) antenna ports field may contain any number of demodulation reference signal (DMRS) code division multiplex (CDM) group(s) without data (e.g., 1 group, 2 groups, 3 groups, etc., may be supported).

Under a second option under the seventh embodiment, the (single) antenna ports field contains two DMRS CDM group(s) without data. In such cases, the DMRS ports in the first DMRS CDM group without data are mapped to the first UE panel, and DMRS ports in the second DMRS CDM group without data are mapped to the second UE panel.

In some cases under this second option, the antenna port combination {0, 2, 3} may be indicated, with antenna port {0} mapped to the first UE panel and antenna ports {2, 3} mapped to the second UE panel.

In some 3GPP networks, to facilitate this use, the antenna port combination {0, 2, 3} can be added to, for example, the following tables in 3GPP Technical Specification (TS) 38.212, v. 17.3.0 (September 2022) for a (1, 2) layer combination:
Table 7.3.1.1.2-10: Transform precoder is disabled, dmrs-Type=1, maxLength=1, rank=3
Table 7.3.1.1.2-14: Transform precoder is disabled, dmrs-Type=1, maxLength=2, rank=3
Table 7.3.1.1.2-18: Transform precoder is disabled, dmrs-Type=2, maxLength=1, rank=3
Table 7.3.1.1.2-22: Transform precoder is disabled, dmrs-Type=2, maxLength=2, rank=3

Finally, it is noted that where the first through seventh embodiments for a single DCI codebook-based simultaneous PUSCH transmission with SDM as have been described herein are interoperable, these may be combined into compound embodiments.

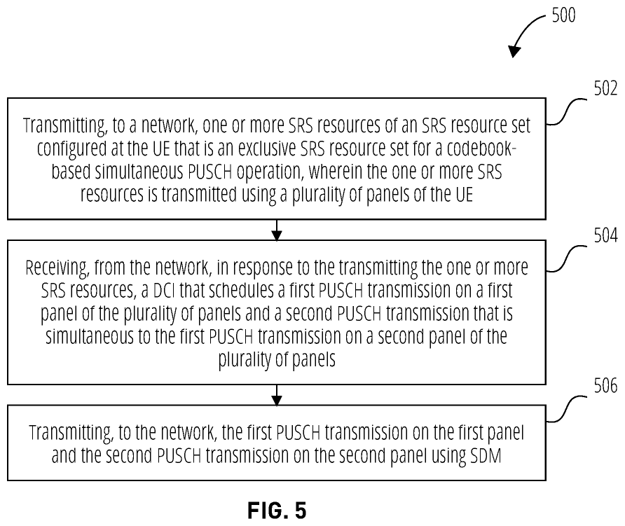

FIG. 5 illustrates a method 500 of a UE, according to embodiments herein. The method 500 includes transmitting 502, to a network, one or more SRS resources of an SRS resource set configured at the UE that is an exclusive SRS resource set for a codebook-based simultaneous PUSCH operation, wherein the one or more SRS resources is transmitted using a plurality of panels of the UE.

The method 500 further includes receiving 504, from the network, in response to the transmitting the one or more SRS resources, a DCI that schedules a first PUSCH transmission on a first panel of the plurality of panels and a second PUSCH transmission that is simultaneous to the first PUSCH transmission on a second panel of the plurality of panels.

The method 500 further includes transmitting 506, to the network, the first PUSCH transmission on the first panel and the second PUSCH transmission on the second panel using SDM.

In some embodiments of the method 500, the UE is not configured for a full power transmission mode 2, and a number of the one or more of SRS resources is greater than two.

In some embodiments of the method 500, the UE is configured for a full power transmission mode 2, and a number of the one or more SRS resources is greater than 4.

In some embodiments of the method 500, a codebook used for the codebook-based simultaneous PUSCH operation is a partial-coherent codebook, even SRS ports used by the one or more SRS resources of the SRS resource set are mapped to the first panel, and odd SRS ports used by the one or more SRS resources of the SRS resource set are mapped to the second panel.

In some embodiments of the method 500, a configuration for a first SRS resource of the one or more of SRS resources indicates a first beam used on the first panel and a second beam used on the second panel and the transmitting the one or more SRS resources comprises transmitting the first SRS resource on the first panel on the first beam and on the second panel on the second beam. In some of these embodiments, even SRS ports used by the first SRS resource are mapped to the first panel and odd SRS ports used by the first SRS resource are mapped to the second panel.

In some embodiments of the method 500, a configuration for a first SRS resource of the one or more of SRS resources indicates a first TCI state for the first panel and a second TCI state for the second panel and the transmitting the one or more of SRS resources comprises transmitting the first SRS resource on the first panel based on the first TCI state and on the second panel based on the second TCI state. In some of these embodiments, even SRS ports used by the first SRS resource are mapped to the first panel and odd SRS ports used by the first SRS resource are mapped to the second panel.

In some embodiments of the method 500, the one or more of SRS resources of the SRS resource set are arranged in one or more pairs, with a first pair of the one or more pairs comprising a first SRS resource of the one or more of SRS resources that is for the first panel and a second SRS resource of the one or more of SRS resources that is for the second panel, the first SRS resource is transmitted on the first panel and the second SRS resource is transmitted on the second panel as part of the transmitting the one or more of SRS resources; and the DCI schedules the first PUSCH transmission on the first panel and the second PUSCH transmission on the second panel using an SRI that indicates the first pair of SRS resources.

In some embodiments of the method 500, the one or more of SRS resources of the SRS resource set are arranged in one or more subsets, a first subset corresponding to the first panel and comprising a first SRS resource of the one or more of SRS resources and a second subset corresponding to the second panel and comprising a second SRS resource of the one or more SRS resources, the first SRS resource is transmitted on the first panel and the second SRS resource is transmitted on the second panel as part of the transmitting the one or more SRS resources, and the DCI schedules the first PUSCH transmission on the first panel and the second PUSCH transmission on the second panel using a first SRI that indicates the first SRS resource from among the first subset and a second SRI that indicates the second SRS resource from among the second subset.

In some embodiments of the method 500, the DCI includes a TPMI indicating a precoding matrix that corresponds to each of the first panel and the second panel, and the method 500 further includes generating the first PUSCH transmission by applying first SRS ports used by the one or more SRS resources to even rows of the precoding matrix and generating the second PUSCH transmission by applying second SRS ports used by the one or more SRS resources to odd rows of the precoding matrix.

In some embodiments of the method 500, the transmitting the one or more SRS resources comprises transmitting a first SRS resource of the one or more SRS resources on the first panel and a second SRS resource of the one or more SRS resources on the second panel and the DCI includes a first TPMI indicating a first precoding matrix that corresponds to the first panel and a second TPMI indicating a second precoding matrix that corresponds to the second panel, and the method 500 further includes generating the first PUSCH transmission by applying first SRS ports used by the first SRS resource to the first precoding matrix and generating the second PUSCH transmission by applying second SRS ports used by the second SRS resource to the second precoding matrix.

In some embodiments of the method 500, the DCI includes an antenna port configuration that indicates a first DMRS CDM group having first one or more DMRS ports that are mapped to the first panel and a second DMRS CDM group having second one or more DMRS ports that are mapped to the second panel, the first PUSCH transmission uses the first one or more DMRS ports, and the second PUSCH transmission uses the second one or more DMRS ports. In some of these embodiments, the first one or more DMRS ports consists of antenna port {0} and the second one or more DMRS ports consists of antenna ports {2, 3}.

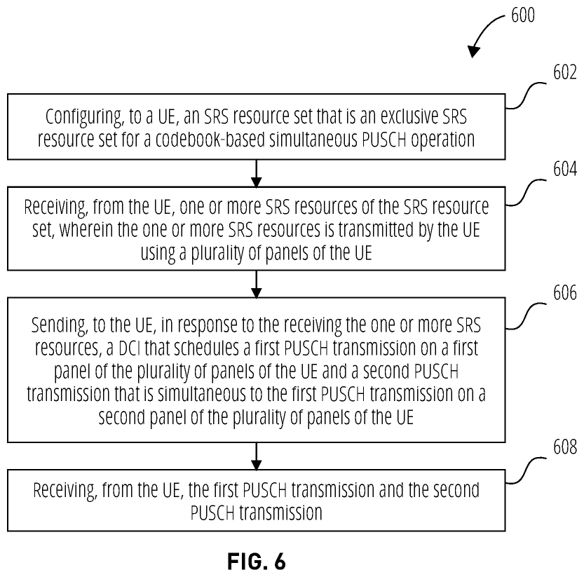

FIG. 6 illustrates a method 600 of a RAN, according to embodiments herein. The method 600 includes configuring 602, to a UE, an SRS resource set that is an exclusive SRS resource set for a codebook-based simultaneous PUSCH operation.

The method 600 further includes receiving 604, from the UE, one or more SRS resources of the SRS resource set, wherein the one or more SRS resources is transmitted by the UE using a plurality of panels of the UE.

The method 600 further includes sending 606, to the UE, in response to the receiving the one or more SRS resources, a DCI that schedules a first PUSCH transmission on a first panel of the plurality of panels of the UE and a second PUSCH transmission that is simultaneous to the first PUSCH transmission on a second panel of the plurality of panels of the UE.

The method 600 further includes receiving 608, from the UE, the first PUSCH transmission and the second PUSCH transmission.

In some embodiments of the method 600, the UE is not configured for a full power transmission mode 2, and a number of the one or more of SRS resources is greater than two.

In some embodiments of the method 600, the UE is configured for a full power transmission mode 2, and a number of the one or more SRS resources is greater than 4.

In some embodiments, the method 600 further includes providing, to the UE, a configuration for a first SRS resource of the one or more of SRS resources that indicates a first beam used on the first panel and a second beam used on the second panel.

In some embodiments, the method 600 further includes providing, to the UE, a configuration for a first SRS resource of the one or more of SRS resources that indicates a first TCI state for the first panel and a second TCI state for the second panel.

In some embodiments of the method 600, the one or more of SRS resources of the SRS resource set are arranged in one or more pairs, with a first pair of the one or more pairs comprising a first SRS resource of the one or more of SRS resources that is for the first panel and a second SRS resource of the one or more of SRS resources that is for the second panel, and the DCI schedules the first PUSCH transmission on the first panel and the second PUSCH transmission on the second panel using an SRS resource indicator (SRI) that indicates the first pair of SRS resources.

In some embodiments of the method 600, the one or more of SRS resources of the SRS resource set are arranged in one or more subsets, a first subset corresponding to the first panel and comprising a first SRS resource of the one or more of SRS resources and a second subset corresponding to the second panel and comprising a second SRS resource of the one or more SRS resources, and the DCI schedules the first PUSCH transmission on the first panel and the second PUSCH transmission on the second panel using a first SRS resource indicator (SRI) that indicates the first SRS resource from among the first subset and a second SRI that indicates the second SRS resource from among the second subset.

In some embodiments of the method 600, the DCI includes a TPMI indicating a precoding matrix that corresponds to each of the first panel and the second panel.

In some embodiments of the method 600, the DCI includes a first TPMI indicating a first precoding matrix that corresponds to the first panel and a second TPMI indicating a second precoding matrix that corresponds to the second panel.

In some embodiments of the method 600, the DCI includes an antenna port configuration that indicates a first DMRS CDM group having first one or more DMRS ports corresponding to the first panel and a second DMRS CDM group having second one or more DMRS ports corresponding to the second panel. In some of these embodiments, the first one or more DMRS ports consists of antenna port {0} and the second one or more DMRS ports consists of antenna ports {2, 3}.

### Exclusive SRS Resource Set Embodiments for Non-Codebook-Based Simultaneous PUSCH Operation

In a first embodiment for a single DCI non-codebook-based simultaneous PUSCH transmission with SDM, it may be that an exclusive SRS resource set configured at the UE for simultaneous PUSCH transmissions is non-codebook-based (e.g., usage=“nonCodebook”).

Under a first option under the first embodiment, it may be that each SRS resource of the SRS resource set can be transmitted from one of the UE panels (and not the other).

Under a second option under the first embodiment, it may be that each SRS resource of the SRS resource set can be transmitted from both UE panels.

In a second embodiment for a single DCI non-codebook-based simultaneous PUSCH transmission with SDM, it may be that an exclusive SRS resource set configured at the UE for simultaneous PUSCH transmissions is non-codebook-based. Further, it may be that the second embodiment corresponds to a case where a beam indications are used to inform the UE of UL beams for use.

Under the second embodiment, in a case where each SRS resource of the SRS resource set can be transmitted from only one of the UE panels, in each SRS resource one spatialRelationInfo parameter (corresponding to a beamforming and having related power control information) can be configured.

Under the second embodiment, in a case where each SRS resource of the SRS resource set can be transmitted from both UE panels, in each SRS resource, up to two spatialRelationInfo parameters can be configured. In such cases, the first spatialRelationInfo parameter applies to a first UE panel, and the second spatialRelationInfo parameter applies to a second UE panel.

Under the second embodiment, up to two total spatialRelationInfo parameters may be used within the SRS resources of the SRS resource set.

In a third embodiment for a single DCI non-codebook-based simultaneous PUSCH transmission with SDM, it may be that an exclusive SRS resource set configured at the UE for simultaneous PUSCH transmissions is non-codebook-based. Further, under the third embodiment, it may be that each SRS resource of the SRS resource set can be transmitted from one of the UE panels (and not the other).

Under the third embodiment, it may be that one of the UE panels is used for even SRS resources (e.g., as indexed within the SRS resource set as SRS resources 0, 2, 4, etc.) and the other of the UE panels is used for odd SRS resources (e.g., as indexed within the SRS resource set as SRS resources 1, 3, 5, etc.).

In a fourth embodiment for a single DCI non-codebook-based simultaneous PUSCH transmission with SDM, it may be that an exclusive SRS resource set configured at the UE for simultaneous PUSCH transmissions is non-codebook-based. Further, it may be that the fourth embodiment corresponds to a case where TCI states are used to inform the UE of the manner of performing UL transmission. It is contemplated that such TCI states could be, for example, UL TCI states and/or joint UL/DL TCI states.

Under the fourth embodiment, two TCI states can be configured for the SRS resources. Each of the up to two TCI states may correspond to a (e.g., different) manner of UL transmission (e.g., beamforming and/or power control) that is used by one of two UE panels used for simultaneous PUSCH transmission. It is contemplated that, for example, the two TCI states in the configuration for the SRS resources could be two UL TCI states, two joint UL/DL TCI states, or a combination of a UL TCI state and a joint UL/DL TCI state.

In cases where each SRS resource of the SRS resource set can only be transmitted from one of the UE panels, for each SRS resource, one TCI state of the two (“paired”) TCI states is applied (causing the SRS resource to be transmitted based on that TCI state and on the UE panel corresponding to that TCI state). Note that in such cases, it may be that one of the UE panels (and its corresponding TCI state) is used for even SRS resources (e.g., as indexed within the SRS resource set as SRS resources 0, 2, 4, etc.) and the other of the UE panels (and its corresponding TCI state) is used for odd SRS resources (e.g., as indexed within the SRS resource set as SRS resources 1, 3, 5, etc.), as is described herein.

In cases where each SRS resource of the SRS resource set can be transmitted from both UE panels, the two TCI states may each be applied with every SRS resource (causing an SRS resource to be transmitted based on both TCI states from each of the UE panels, with a portion of an SRS resource transmitted on a first UE panel according to one of the TCI states and a portion of an SRS resource transmitted on the second UE panel according to the second TCI state).

In a fifth embodiment for a single DCI non-codebook-based simultaneous PUSCH transmission with SDM, it may be that an exclusive SRS resource set configured at the UE for simultaneous PUSCH transmissions is non-codebook-based.

Under a first option under the fifth embodiment, it may be that a single SRI field is present in DCI provided by the network. This SRI field is used to indicate one or more SRS resources of the SRS resource set. This may correspond to cases where single SRS resource(s) may be transmitted across both UE panels (such that the single SRI indicates an SRS resource that spatially covers both UE panels).

Accordingly, once the SRS resource set is transmitted by the UE (with the SRS resources sent across both UE panels), the network can indicate an SRI value for one or more SRS resources by placing a corresponding value for the desired one or more SRS resources in an SRI field of DCI. In response, the UE prepares and sends a first PUSCH transmission for the first UE panel and a (simultaneous) second PUSCH transmission for the second UE panel based on the selected SRS resource(s).

Under a second option under the fifth embodiment, it may be that two SRI fields in DCI provided by the network. The SRI fields indicate first and second SRS resources of the SRS resource set. This may correspond to cases where each SRS resource of the SRS resource set can be transmitted from one of the UE panels (and not the other). Accordingly, the first SRI field is used to select/indicate one or more SRS resources of the SRS resource set that is mapped to the first UE panel, and the second SRI field selects/indicates one or more SRS resources of the SRS resource set that is mapped to the second UE panel. This may correspond to cases where SRS resources of the SRS resource set can be transmitted from one of the UE panels (and not the other).

Accordingly, once the SRS resource set is transmitted by the UE (with the SRS resources sent on their corresponding UE panels), the network can indicate two SRI values for two SRS resources by placing a corresponding value for the desired SRS resources in the appropriate ones of the SRI fields. One of the SRI fields contains an SRI value corresponding to first one or more SRS resources used on the first UE panel, and the other of the SRI fields contains an SRI value corresponding to second one or more SRS resources used on the second UE panel. In response, the UE prepares and sends a first PUSCH transmission for the first UE panel based on the first one or more SRS resources and a (simultaneous) second PUSCH transmission for the second UE panel based on the second one or more SRS resources.

Under a third option under the fifth embodiment, it may be that a single SRI field is present in DCI provided by the network. This SRI field is used to indicate one or more SRS resources of the SRS resource set. Some indicated SRS resources are transmitted from the first panel, and the other indicated SRS resources are transmitted from the second panel. This may correspond to cases where each SRS resource of the SRS resource set can be transmitted from one of the UE panels (and not the other).

Accordingly, once the SRS resource set is transmitted by the UE (with the SRS resources sent on their corresponding UE panels), the network can indicate an SRI value for one or more resources by placing a corresponding value for the desired SRS resources in the SRI field. In response, and in the case that the SRI value indicates at least two SRS resources, the UE prepares and sends a first PUSCH transmission for the first UE panel based on one of the indicated SRS resources and/or a (simultaneous) second PUSCH transmission for the second UE panel based on another of the indicated SRS resources.

In a sixth embodiment for a single DCI non-codebook-based simultaneous PUSCH transmission with SDM, it may be that an exclusive SRS resource set configured at the UE for simultaneous PUSCH transmissions is non-codebook-based. Under the sixth embodiment, there may be a single antenna ports field provided by the network in DCI.

Under a first option under the sixth embodiment, the (single) antenna ports field may contain any number of demodulation reference signal (DMRS) code division multiplex (CDM) group(s) without data (e.g., 1 group, 2 groups, 3 groups, etc., may be supported).

Under a second option under the seventh embodiment, the (single) antenna ports field contains two DMRS CDM group(s) without data. In such cases, the DMRS ports in the first DMRS CDM group without data are mapped to the first UE panel, and DMRS ports in the second DMRS CDM group without data are mapped to the second UE panel.

In some cases under this second option, the antenna port combination {0, 2, 3} may be indicated, with antenna port {0} mapped to the first UE panel and antenna ports {2, 3} mapped to the second UE panel.

In some 3GPP networks, to facilitate this use, the antenna port combination {0, 2, 3} can be added to, for example, the following tables in 3GPP Technical Specification (TS) 38.212, v. 17.3.0 (September 2022) for a (1, 2) layer combination:
Table 7.3.1.1.2-10: Transform precoder is disabled, dmrs-Type=1, maxLength=1, rank=3
Table 7.3.1.1.2-14: Transform precoder is disabled, dmrs-Type=1, maxLength=2, rank=3
Table 7.3.1.1.2-18: Transform precoder is disabled, dmrs-Type=2, maxLength=1, rank=3
Table 7.3.1.1.2-22: Transform precoder is disabled, dmrs-Type=2, maxLength=2, rank=3

Finally, it is noted that where the first through sixth embodiments for a single DCI non-codebook-based simultaneous PUSCH transmission with SDM as have been described herein are interoperable, these may be combined into compound embodiments.

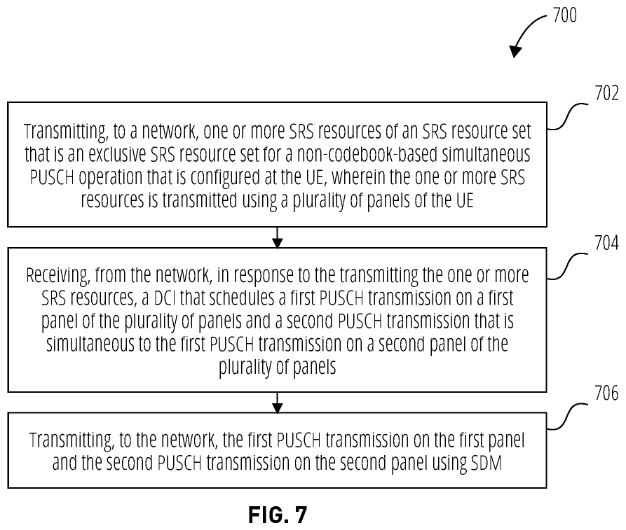

FIG. 7 illustrates a method 700 of a UE, according to embodiments herein. The method 700 includes transmitting 702, to a network, one or more SRS resources of an SRS resource set that is an exclusive SRS resource set for a non-codebook-based simultaneous PUSCH operation that is configured at the UE, wherein the one or more SRS resources is transmitted using a plurality of panels of the UE.

The method 700 further includes receiving 704, from the network, in response to the transmitting the one or more SRS resources, a DCI that schedules a first PUSCH transmission on a first panel of the plurality of panels and a second PUSCH transmission that is simultaneous to the first PUSCH transmission on a second panel of the plurality of panels.

The method 700 further includes transmitting 706, to the network, the first PUSCH transmission on the first panel and the second PUSCH transmission on the second panel using SDM.

In some embodiments of the method 700, a first SRS resource of the SRS resource set is transmitted on the first panel and a second SRS resource of the SRS resource set is transmitted on the second panel.

In some embodiments of the method 700, each of a first SRS resource of the SRS resource set and a second SRS resource of the SRS resource set are transmitted on each of the first panel and the second panel.

In some embodiments of the method 700, a configuration for a first SRS resource of the one or more SRS resources indicates a first beam used on the first panel and a second beam used on the second panel and the transmitting the one or more SRS resources comprises transmitting the first SRS resource on the first panel on the first beam and on the second panel on the second beam.

In some embodiments of the method 700, a configuration for a first SRS resource of the one or more SRS resources indicates a first TCI state for the first panel and a second TCI state for the second panel. In some of these embodiments, the method 700 further includes identifying that the first SRS resource has an even index within the SRS resource set, and the transmitting the one or more SRS resources comprises transmitting the first SRS resource on the first panel based on the first TCI state. In some of these cases, the method 700 further includes identifying that the first SRS resource has an odd index within the SRS resource set, and the transmitting the one or more SRS resources comprises transmitting the first SRS resource on the second panel based on the second TCI state. In some of these embodiments, the transmitting the one or more SRS resources comprises transmitting the first SRS resource on the first panel based on the first TCI state and on the second panel based on the second TCI state.

In some embodiments of the method 700, first one or more SRS resources of the one or more SRS resources having even indexes within the SRS resource set are transmitted on the first panel, and wherein second one or more SRS resources of the one or more SRS resources having odd indexes within the SRS resource set are transmitted on the second panel.

In some embodiments of the method 700, the DCI schedules the first PUSCH transmission on the first panel and the second PUSCH transmission on the second panel using a first SRI that indicates a first SRS resource of the one or more SRS resources that is transmitted on the first panel and the second panel as part of the transmitting the one or more SRS resources.

In some embodiments of the method 700, the DCI schedules the first PUSCH transmission on the first panel and the second PUSCH transmission on the second panel using a first SRI that indicates a first SRS resource of the one or more SRS resources that is transmitted on the first panel as part of the transmitting the one or more SRS resources and a second SRI that indicates a second SRS resource of the one or more SRS resources that is transmitted on the second panel as part of the transmitting the one or more SRS resources.

In some embodiments of the method 700, the DCI includes an antenna port configuration that indicates a first DMRS CDM group having first DMRS ports that are mapped to the first panel and a second DMRS CDM group having second DMRS ports that are mapped to the second panel, the first PUSCH transmission uses the first DMRS ports, and the second PUSCH transmission uses the second DMRS ports. In some of these embodiments, the first one or more DMRS ports consists of antenna port {0} and the second one or more DMRS ports consists of antenna ports {2, 3}.

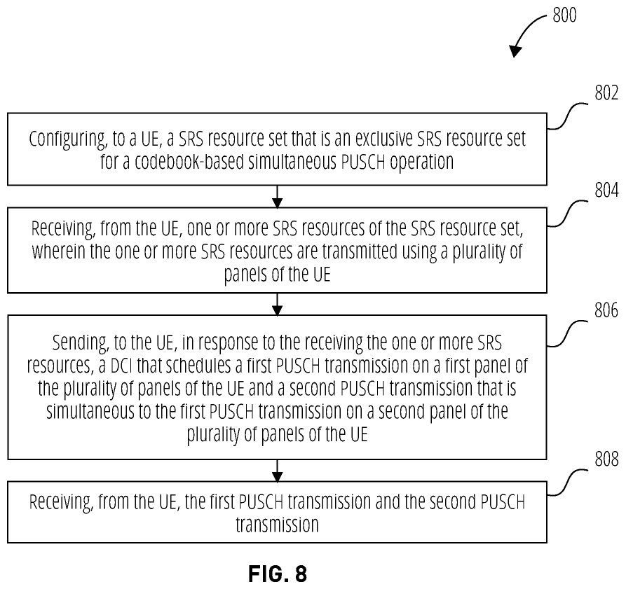

FIG. 8 illustrates a method 800 of a RAN, according to embodiments herein. The method 800 includes configuring 802, to a UE, an SRS resource set that is an exclusive SRS resource set for a codebook-based simultaneous PUSCH operation.

The method 800 further includes receiving 804, from the UE, one or more SRS resources of the SRS resource set, wherein the one or more SRS resources are transmitted using a plurality of panels of the UE.

The method 800 further includes sending 806, to the UE, in response to the receiving the one or more SRS resources, a DCI that schedules a first PUSCH transmission on a first panel of the plurality of panels of the UE and a second PUSCH transmission that is simultaneous to the first PUSCH transmission on a second panel of the plurality of panels of the UE.

The method 800 further includes receiving 808, from the UE, the first PUSCH transmission and the second PUSCH transmission.

In some embodiments, the method 800 further includes providing, to the UE, a configuration for a first SRS resource of the one or more SRS resources that indicates a first beam used on the first panel and a second beam used on the second panel.

In some embodiments, the method 800 further includes providing, to the UE, a configuration for a first SRS resource of the one or more SRS resources that indicates a first TCI state for the first panel and a second TCI state for the second panel.

In some embodiments of the method 800, the DCI schedules the first PUSCH transmission on the first panel and the second PUSCH transmission on the second panel using a first SRI that indicates a first SRS resource of the one or more SRS resources that is transmitted on the first panel and the second panel.

In some embodiments of the method 800, the DCI schedules the first PUSCH transmission on the first panel and the second PUSCH transmission on the second panel using a first SRI that indicates a first SRS resource of the one or more SRS resources that is transmitted on the first panel and a second SRI that indicates a second SRS resource of the one or more SRS resources that is transmitted on the second panel.

In some embodiments of the method 800, the DCI includes an antenna port configuration that indicates a first DMRS CDM group having first DMRS ports corresponding to the first panel and a second DMRS CDM group having second DMRS ports corresponding the second panel. In some of these embodiments, the first one or more DMRS ports consists of antenna port {0} and the second one or more DMRS ports consists of antenna ports {2, 3}.

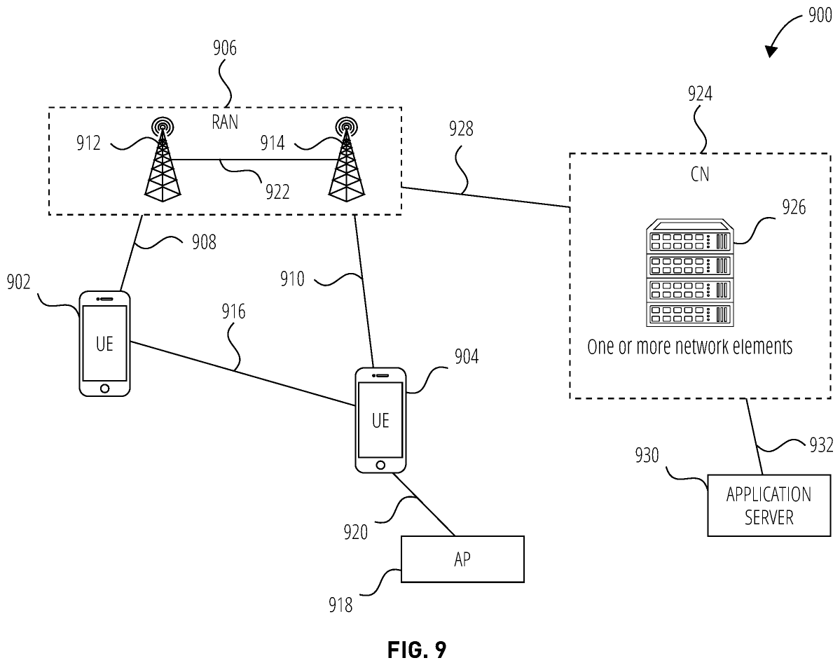

FIG. 9 illustrates an example architecture of a wireless communication system 900, according to embodiments disclosed herein. The following description is provided for an example wireless communication system 900 that operates in conjunction with the LTE system standards and/or 5G or NR system standards as provided by 3GPP technical specifications.

As shown by FIG. 9, the wireless communication system 900 includes UE 902 and UE 904 (although any number of UEs may be used). In this example, the UE 902 and the UE 904 are illustrated as smartphones (e.g., handheld touchscreen mobile computing devices connectable to one or more cellular networks), but may also comprise any mobile or non-mobile computing device configured for wireless communication.

The UE 902 and UE 904 may be configured to communicatively couple with a RAN 906. In embodiments, the RAN 906 may be NG-RAN, E-UTRAN, etc. The UE 902 and UE 904 utilize connections (or channels) (shown as connection 908 and connection 910, respectively) with the RAN 906, each of which comprises a physical communications interface. The RAN 906 can include one or more base stations (such as base station 912 and base station 914) that enable the connection 908 and connection 910.

In this example, the connection 908 and connection 910 are air interfaces to enable such communicative coupling, and may be consistent with RAT(s) used by the RAN 906, such as, for example, an LTE and/or NR.

In some embodiments, the UE 902 and UE 904 may also directly exchange communication data via a sidelink interface 916. The UE 904 is shown to be configured to access an access point (shown as AP 918) via connection 920. By way of example, the connection 920 can comprise a local wireless connection, such as a connection consistent with any IEEE 802.11 protocol, wherein the AP 918 may comprise a Wi-Fi® router. In this example, the AP 918 may be connected to another network (for example, the Internet) without going through a CN 924.

In embodiments, the UE 902 and UE 904 can be configured to communicate using orthogonal frequency division multiplexing (OFDM) communication signals with each other or with the base station 912 and/or the base station 914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 912 or base station 914 may be implemented as one or more software entities running on server computers as part of a virtual network. In addition, or in other embodiments, the base station 912 or base station 914 may be configured to communicate with one another via interface 922. In embodiments where the wireless communication system 900 is an LTE system (e.g., when the CN 924 is an EPC), the interface 922 may be an X2 interface. The X2 interface may be defined between two or more base stations (e.g., two or more eNBs and the like) that connect to an EPC, and/or between two eNBs connecting to the EPC. In embodiments where the wireless communication system 900 is an NR system (e.g., when CN 924 is a 5GC), the interface 922 may be an Xn interface. The Xn interface is defined between two or more base stations (e.g., two or more gNBs and the like) that connect to 5GC, between a base station 912 (e.g., a gNB) connecting to 5GC and an eNB, and/or between two eNBs connecting to 5GC (e.g., CN 924).

The RAN 906 is shown to be communicatively coupled to the CN 924. The CN 924 may comprise one or more network elements 926, which are configured to offer various data and telecommunications services to customers/subscribers (e.g., users of UE 902 and UE 904) who are connected to the CN 924 via the RAN 906. The components of the CN 924 may be implemented in one physical device or separate physical devices including components to read and execute instructions from a machine-readable or computer-readable medium (e.g., a non-transitory machine-readable storage medium).

In embodiments, the CN 924 may be an EPC, and the RAN 906 may be connected with the CN 924 via an S1 interface 928. In embodiments, the S1 interface 928 may be split into two parts, an S1 user plane (S1-U) interface, which carries traffic data between the base station 912 or base station 914 and a serving gateway (S-GW), and the S1-MME interface, which is a signaling interface between the base station 912 or base station 914 and mobility management entities (MMEs).

In embodiments, the CN 924 may be a 5GC, and the RAN 906 may be connected with the CN 924 via an NG interface 928. In embodiments, the NG interface 928 may be split into two parts, an NG user plane (NG-U) interface, which carries traffic data between the base station 912 or base station 914 and a user plane function (UPF), and the S1 control plane (NG-C) interface, which is a signaling interface between the base station 912 or base station 914 and access and mobility management functions (AMFs).

Generally, an application server 930 may be an element offering applications that use internet protocol (IP) bearer resources with the CN 924 (e.g., packet switched data services). The application server 930 can also be configured to support one or more communication services (e.g., VoIP sessions, group communication sessions, etc.) for the UE 902 and UE 904 via the CN 924. The application server 930 may communicate with the CN 924 through an IP communications interface 932.

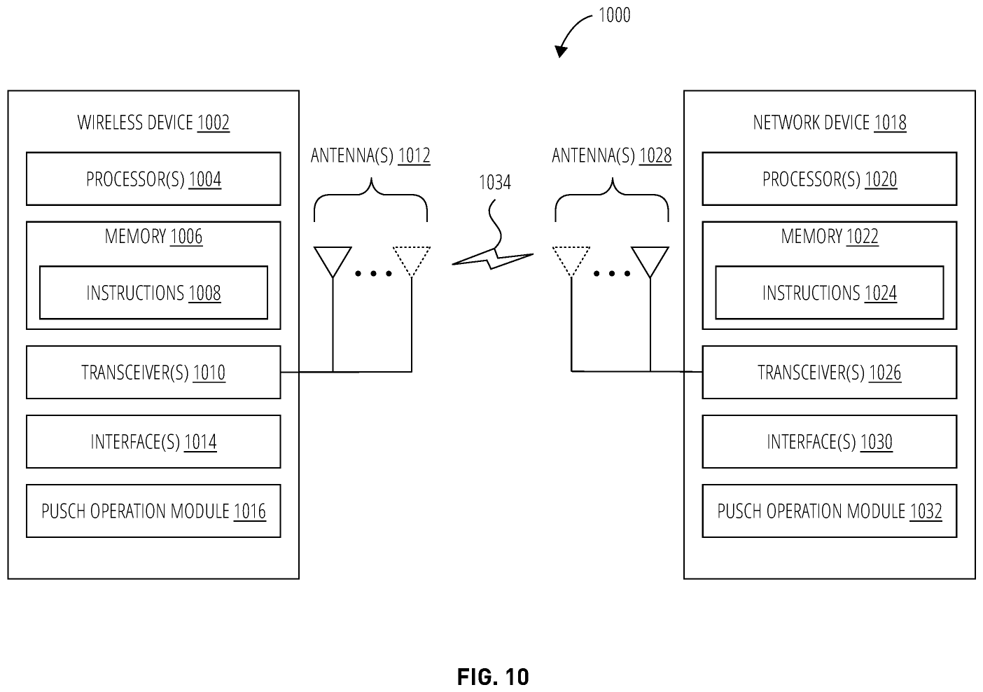

FIG. 10 illustrates a system 1000 for performing signaling 1034 between a wireless device 1002 and a network device 1018, according to embodiments disclosed herein. The system 1000 may be a portion of a wireless communications system as herein described. The wireless device 1002 may be, for example, a UE of a wireless communication system. The network device 1018 may be, for example, a base station (e.g., an eNB or a gNB) of a wireless communication system.

The wireless device 1002 may include one or more processor(s) 1004. The processor(s) 1004 may execute instructions such that various operations of the wireless device 1002 are performed, as described herein. The processor(s) 1004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1002 may include a memory 1006. The memory 1006 may be a non-transitory computer-readable storage medium that stores instructions 1008 (which may include, for example, the instructions being executed by the processor(s) 1004). The instructions 1008 may also be referred to as program code or a computer program. The memory 1006 may also store data used by, and results computed by, the processor(s) 1004.

The wireless device 1002 may include one or more transceiver(s) 1010 that may include radio frequency (RF) transmitter and/or receiver circuitry that use the antenna(s) 1012 of the wireless device 1002 to facilitate signaling (e.g., the signaling 1034) to and/or from the wireless device 1002 with other devices (e.g., the network device 1018) according to corresponding RATs.

The wireless device 1002 may include one or more antenna(s) 1012 (e.g., one, two, four, or more). For embodiments with multiple antenna(s) 1012, the wireless device 1002 may leverage the spatial diversity of such multiple antenna(s) 1012 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 1002 may be accomplished according to precoding (or digital beamforming) that is applied at the wireless device 1002 that multiplexes the data streams across the antenna(s) 1012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1002 may implement analog beamforming techniques, whereby phases of the signals sent by the antenna(s) 1012 are relatively adjusted such that the (joint) transmission of the antenna(s) 1012 can be directed (this is sometimes referred to as beam steering).

The wireless device 1002 may include one or more interface(s) 1014. The interface(s) 1014 may be used to provide input to or output from the wireless device 1002. For example, a wireless device 1002 that is a UE may include interface(s) 1014 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1010/antenna(s) 1012 already described) that allow for communication between the UE and other devices and may operate according to known protocols (e.g., Wi-Fi®, Bluetooth®, and the like).

The wireless device 1002 may include a PUSCH operation module 1016. The PUSCH operation module 1016 may be implemented via hardware, software, or combinations thereof. For example, the PUSCH operation module 1016 may be implemented as a processor, circuit, and/or instructions 1008 stored in the memory 1006 and executed by the processor(s) 1004. In some examples, the PUSCH operation module 1016 may be integrated within the processor(s) 1004 and/or the transceiver(s) 1010. For example, the PUSCH operation module 1016 may be implemented by a combination of software components (e.g., executed by a DSP or a general processor) and hardware components (e.g., logic gates and circuitry) within the processor(s) 1004 or the transceiver(s) 1010.

The PUSCH operation module 1016 may be used for various aspects of the present disclosure, for example, aspects of FIG. 1 through FIG. 8. For example, the PUSCH operation module 1016 may be configured to perform UE based functions of single DCI codebook-based simultaneous PUSCH transmission with SDM and/or single DCI non-codebook-based simultaneous PUSCH transmission with SDM, as described herein.

The network device 1018 may include one or more processor(s) 1020. The processor(s) 1020 may execute instructions such that various operations of the network device 1018 are performed, as described herein. The processor(s) 1020 may include one or more baseband processors implemented using, for example, a CPU, a DSP, an ASIC, a controller, an FPGA device, another hardware device, a firmware device, or any combination thereof configured to perform the operations described herein.

The network device 1018 may include a memory 1022. The memory 1022 may be a non-transitory computer-readable storage medium that stores instructions 1024 (which may include, for example, the instructions being executed by the processor(s) 1020). The instructions 1024 may also be referred to as program code or a computer program. The memory 1022 may also store data used by, and results computed by, the processor(s) 1020.

The network device 1018 may include one or more transceiver(s) 1026 that may include RF transmitter and/or receiver circuitry that use the antenna(s) 1028 of the network device 1018 to facilitate signaling (e.g., the signaling 1034) to and/or from the network device 1018 with other devices (e.g., the wireless device 1002) according to corresponding RATs.

The network device 1018 may include one or more antenna(s) 1028 (e.g., one, two, four, or more). In embodiments having multiple antenna(s) 1028, the network device 1018 may perform MIMO, digital beamforming, analog beamforming, beam steering, etc., as has been described.

The network device 1018 may include one or more interface(s) 1030. The interface(s) 1030 may be used to provide input to or output from the network device 1018. For example, a network device 1018 that is a base station may include interface(s) 1030 made up of transmitters, receivers, and other circuitry (e.g., other than the transceiver(s) 1026/antenna(s) 1028 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1018 may include a PUSCH operation module 1032. The PUSCH operation module 1032 may be implemented via hardware, software, or combinations thereof. For example, the PUSCH operation module 1032 may be implemented as a processor, circuit, and/or instructions 1024 stored in the memory 1022 and executed by the processor(s) 1020. In some examples, the PUSCH operation module 1032 may be integrated within the processor(s) 1020 and/or the transceiver(s) 1026. For example, the PUSCH operation module 1032 may be implemented by a combination of software components (e.g., executed by a DSP or a general processor) and hardware components (e.g., logic gates and circuitry) within the processor(s) 1020 or the transceiver(s) 1026.

The PUSCH operation module 1032 may be used for various aspects of the present disclosure, for example, aspects of FIG. 1 through FIG. 8. For example, the PUSCH operation module 1032 may be configured to perform network based functions of single DCI codebook-based simultaneous PUSCH transmission with SDM and/or single DCI non-codebook-based simultaneous PUSCH transmission with SDM, as described herein.

Embodiments contemplated herein include an apparatus comprising means to perform one or more elements of any of the method 500 and the method 700. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 500 and the method 700. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of any of the method 500 and the method 700. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 500 and the method 700. This apparatus may be, for example, an apparatus of a UE (such as a wireless device 1002 that is a UE, as described herein).

Embodiments contemplated herein include a signal as described in or related to one or more elements of any of the method 500 and the method 700.

Embodiments contemplated herein include a computer program or computer program product comprising instructions, wherein execution of the program by a processor is to cause the processor to carry out one or more elements of any of the method 500 and the method 700. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

Embodiments contemplated herein include an apparatus comprising means to perform one or more elements of any of the method 600 and the method 800. This apparatus may be, for example, an apparatus of a base station of a RAN (such as a network device 1018 that is a base station, as described herein).

Embodiments contemplated herein include one or more non-transitory computer-readable media comprising instructions to cause an electronic device, upon execution of the instructions by one or more processors of the electronic device, to perform one or more elements of any of the method 600 and the method 800. This non-transitory computer-readable media may be, for example, a memory of a base station of a RAN (such as a memory 1022 of a network device 1018 that is a base station, as described herein).

Embodiments contemplated herein include an apparatus comprising logic, modules, or circuitry to perform one or more elements of any of the method 600 and the method 800. This apparatus may be, for example, an apparatus of a base station of a RAN (such as a network device 1018 that is a base station, as described herein).

Embodiments contemplated herein include an apparatus comprising: one or more processors and one or more computer-readable media comprising instructions that, when executed by the one or more processors, cause the one or more processors to perform one or more elements of any of the method 600 and the method 800. This apparatus may be, for example, an apparatus of a base station of a RAN (such as a network device 1018 that is a base station, as described herein).

Embodiments contemplated herein include a signal as described in or related to one or more elements of any of the method 600 and the method 800.

Embodiments contemplated herein include a computer program or computer program product comprising instructions, wherein execution of the program by a processing element is to cause the processing element to carry out one or more elements of any of the method 600 and the method 800. The processor may be a processor of a base station of a RAN (such as a processor(s) 1020 of a network device 1018 that is a base station, as described herein). These instructions may be, for example, located in the processor and/or on a memory of the base station of a RAN (such as a memory 1022 of a network device 1018 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
transmitting, to a network, one or more sounding reference signal (SRS) resources of an SRS resource set that is an exclusive SRS resource set for a non-codebook-based simultaneous physical uplink shared channel (PUSCH) operation that is configured at the UE, wherein the one or more SRS resources is transmitted using a plurality of panels of the UE;
receiving, from the network, in response to the transmitting the one or more SRS resources, a downlink control information (DCI) that schedules a first PUSCH transmission on a first panel of the plurality of panels and a second PUSCH transmission that is simultaneous to the first PUSCH transmission on a second panel of the plurality of panels; and
transmitting, to the network, the first PUSCH transmission on the first panel and the second PUSCH transmission on the second panel using spatial division multiplexing (SDM).

2. The method of claim 1, wherein a first SRS resource of the SRS resource set is transmitted on the first panel and a second SRS resource of the SRS resource set is transmitted on the second panel.

3. The method of claim 1, wherein each of a first SRS resource of the SRS resource set and a second SRS resource of the SRS resource set are transmitted on each of the first panel and the second panel.

4. The method of claim 1, wherein:
a configuration for a first SRS resource of the one or more SRS resources indicates a first beam used on the first panel and a second beam used on the second panel; and
the transmitting the one or more SRS resources comprises transmitting the first SRS resource on the first panel on the first beam and on the second panel on the second beam.

5. The method of claim 1, wherein a configuration for a first SRS resource of the one or more SRS resources indicates a first transmission configuration indicator (TCI) state for the first panel and a second TCI state for the second panel.

6. The method of claim 5, further comprising identifying that the first SRS resource has an even index within the SRS resource set; wherein the transmitting the one or more SRS resources comprises transmitting the first SRS resource on the first panel based on the first TCI state.

7. The method of claim 5, further comprising identifying that the first SRS resource has an odd index within the SRS resource set; wherein the transmitting the one or more SRS resources comprises transmitting the first SRS resource on the second panel based on the second TCI state.

8. The method of claim 5, wherein the transmitting the one or more SRS resources comprises transmitting the first SRS resource on the first panel based on the first TCI state and on the second panel based on the second TCI state.

9. The method of claim 1, wherein first one or more SRS resources of the one or more SRS resources having even indexes within the SRS resource set are transmitted on the first panel, and wherein second one or more SRS resources of the one or more SRS resources having odd indexes within the SRS resource set are transmitted on the second panel.

10. The method of claim 1, wherein the DCI schedules the first PUSCH transmission on the first panel and the second PUSCH transmission on the second panel using a first SRS resource indicator (SRI) that indicates a first SRS resource of the one or more SRS resources that is transmitted on the first panel and the second panel as part of the transmitting the one or more SRS resources.

11. The method of claim 1, wherein the DCI schedules the first PUSCH transmission on the first panel and the second PUSCH transmission on the second panel using:
a first SRS resource indicator (SRI) that indicates a first SRS resource of the one or more SRS resources that is transmitted on the first panel as part of the transmitting the one or more SRS resources; and
a second SRI that indicates a second SRS resource of the one or more SRS resources that is transmitted on the second panel as part of the transmitting the one or more SRS resources.

12. The method of claim 1, wherein:
the DCI includes an antenna port configuration that indicates a first demodulation reference signal (DMRS) code division multiplex (CDM) group having first DMRS ports that are mapped to the first panel and a second DMRS CDM group having second DMRS ports that are mapped to the second panel;
the first PUSCH transmission uses the first DMRS ports; and
the second PUSCH transmission uses the second DMRS ports.

13. The method of claim 12, wherein the first one or more DMRS ports consists of antenna port {0} and the second one or more DMRS ports consists of antenna ports {2, 3}.

14. A method of a radio access network (RAN), comprising:
configuring, to a user equipment (UE), a sounding reference signal (SRS) resource set that is an exclusive SRS resource set for a codebook-based simultaneous physical uplink shared channel (PUSCH) operation;
receiving, from the UE, one or more SRS resources of the SRS resource set, wherein the one or more SRS resources are transmitted using a plurality of panels of the UE;
sending, to the UE, in response to the receiving the one or more SRS resources, a downlink control information (DCI) that schedules a first PUSCH transmission on a first panel of the plurality of panels of the UE and a second PUSCH transmission that is simultaneous to the first PUSCH transmission on a second panel of the plurality of panels of the UE; and
receiving, from the UE, the first PUSCH transmission and the second PUSCH transmission.

15. The method of claim 14, further comprising providing, to the UE, a configuration for a first SRS resource of the one or more SRS resources that indicates a first beam used on the first panel and a second beam used on the second panel.

16. The method of claim 14, further comprising providing, to the UE, a configuration for a first SRS resource of the one or more SRS resources that indicates a first transmission configuration indicator (TCI) state for the first panel and a second TCI state for the second panel.

17. The method of claim 14, wherein the DCI schedules the first PUSCH transmission on the first panel and the second PUSCH transmission on the second panel using a first SRS resource indicator (SRI) that indicates a first SRS resource of the one or more SRS resources that is transmitted on the first panel and the second panel.

18. The method of claim 14, wherein the DCI schedules the first PUSCH transmission on the first panel and the second PUSCH transmission on the second panel using:
a first SRS resource indicator (SRI) that indicates a first SRS resource of the one or more SRS resources that is transmitted on the first panel; and
a second SRI that indicates a second SRS resource of the one or more SRS resources that is transmitted on the second panel.

19. The method of claim 14, wherein the DCI includes an antenna port configuration that indicates a first demodulation reference signal (DMRS) code division multiplex (CDM) group having first DMRS ports corresponding to the first panel and a second DMRS CDM group having second DMRS ports corresponding the second panel.

20. The method of claim 19, wherein the first one or more DMRS ports consists of antenna port {0} and the second one or more DMRS ports consists of antenna ports {2, 3}.

21-23. (canceled)
